(19) United States
(12) Patent Application Publication
(10) Pub. No.: US 2026/0168449 A1
(43) Pub. Date: Jun. 18, 2026

(54) METHODS AND IOT SYSTEMS FOR ENERGY-SAVING CONTROL OF SMART GAS TERMINALS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yunbai CHEN, Chengdu (CN); Jun WANG, Chengdu (CN)

(73) Assignee: CHENGDU QINCHUAN IOT TECHNOLOGY CO., LTD., Chengdu (CN)

(21) Appl. No.: 19/536,205

(22) Filed: Feb. 10, 2026

(30) Foreign Application Priority Data
Jan. 15, 2026 (CN) 202610053092.2

(51) Int. Cl. F02D 35/02

(52) U.S. Cl. CPC F02D 35/028

(57) ABSTRACT

Disclosed is a method and an IoT system for energy-saving control of smart gas terminals, the method is executed based on a smart gas management platform of the IoT system, and includes: obtaining gas usage data and gas image data of a target user through a smart gas object platform; determining a combustion state distribution based on the gas usage data and the gas image data; in response to determining that the combustion state distribution satisfies a preset condition, determining an energy-saving parameter based on the combustion state distribution; and determining an energy-saving instruction and a driven adjustment instruction based on the energy-saving parameter, so as to adjust a valve opening of a valve control device based on the energy-saving instruction and the driven adjustment instruction.

### CROSS-REFERENCE TO RELATED APPLICATIONS

This application claims priority to Chinese Patent Application No. 202610053092.2, filed on Jan. 15, 2026, the contents of which are hereby incorporated by reference.

### TECHNICAL FIELD

The present disclosure generally relates to a field of Internet of Things technology, and in particular to a method and an Internet of Things (IoT) system for energy-saving control of smart gas terminals.

### BACKGROUND

With the development of social economy, combustible gases such as natural gas, as non-renewable energy sources, are being applied increasingly widely in daily life and industrial production, and their consumption continues to grow annually. While meeting human production and living needs, how to carry out gas energy-saving management has become an urgent problem to be solved in current gas operations. Due to differences in gas pipelines, gas consumption equipment, environments, etc., among different gas terminal users, there are different combustion usage situations. Therefore, gas energy-saving management requires formulating corresponding energy-saving measures and management strategies according to specific situations.

Therefore, it is desirable to provide a method and an IoT system for energy-saving control of smart gas terminals, which helps formulate corresponding gas energy-saving measures and management strategies based on gas combustion.

### SUMMARY

One or more embodiments of the present disclosure provide an IoT system for energy-saving control of smart gas terminals, comprising: a smart gas user platform, a smart gas service platform, a smart gas management platform, a smart gas sensing network platform, and a smart gas object platform sequentially connected; the smart gas object platform includes a supervisory sensing device and an image acquisition device, the supervisory sensing device and the image acquisition device are disposed at a gas consumption terminal, the supervisory sensing device is configured to acquire gas usage data of a target user, and the image acquisition device is configured to acquire gas image data of the target user; the smart gas management platform is configured to: obtain the gas usage data and the gas image data of the target user through the smart gas object platform; determine a combustion state distribution based on the gas usage data and the gas image data; in response to determining that the combustion state distribution satisfies a preset condition, determine an energy-saving parameter based on the combustion state distribution; and determine an energy-saving instruction and a driven adjustment instruction based on the energy-saving parameter, so as to adjust a valve opening of a valve control device based on the energy-saving instruction and the driven adjustment instruction.

One or more embodiments of the present disclosure provide a method for energy-saving control of smart gas terminals, executed by the smart gas management platform and comprises: obtaining the gas usage data and the gas image data of the target user through the smart gas object platform; determining a combustion state distribution based on the gas usage data and the gas image data; in response to determining that the combustion state distribution satisfies a preset condition, determining an energy-saving parameter based on the combustion state distribution; and determining an energy-saving instruction and a driven adjustment instruction based on the energy-saving parameter, so as to adjust a valve opening of a valve control device based on the energy-saving instruction and the driven adjustment instruction.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numbers denote the same structures, wherein:

FIG. 1 is a schematic diagram illustrating an exemplary structure of an IoT system for energy-saving control of smart gas terminals according to some embodiments of the present disclosure.

FIG. 2 is a flowchart illustrating an exemplary process for energy-saving control of smart gas terminals according to some embodiments of the present disclosure.

FIG. 3 is a schematic diagram illustrating an exemplary state prediction model according to some embodiments of the present disclosure.

FIG. 4 is a flowchart illustrating an exemplary process for determining an energy-saving parameter according to some embodiments of the present disclosure.

### DETAILED DESCRIPTION

To more clearly illustrate the technical solutions in the embodiments of the present disclosure, the following briefly describes the accompanying drawings required for describing the embodiments. Obviously, the accompanying drawings in the following description show merely some examples or embodiments of the present disclosure. A person of ordinary skill in the art may still derive other drawings from these accompanying drawings without creative efforts for applying the present disclosure to other similar scenarios. Unless obviously obtained from the context or the context illustrates otherwise, the same numeral in the drawings refers to the same structure or operation.

It should be understood that the terms “system”, “device”, “unit” and/or “module” used herein are a method for distinguishing components, elements, parts, sections or assemblies of different levels from each other. However, if other words may achieve the same purpose, the words may be replaced by other expressions.

As shown in the present disclosure and the claims, unless the context clearly indicates an exception, the terms “a”, “an”, “one” and/or “the” are not specifically limited to the singular, and may also include the plural. Generally, the terms “include” and “contain” only suggest including clearly identified steps and elements. These steps and elements do not form an exclusive list. A manner or device may also include other steps or elements.

The present disclosure uses flowcharts to illustrate operations performed by the system according to the embodiments of the present disclosure. It should be understood that the preceding or following operations are not necessarily performed precisely in order. Instead, the steps may be processed in reverse order or simultaneously. Meanwhile, other operations may be added to these processes, or one or more operations may be removed from these processes.

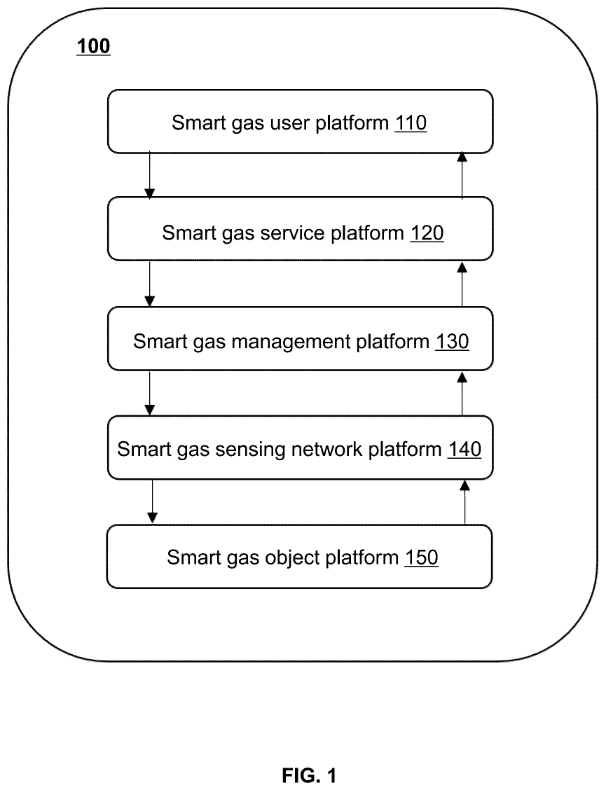

FIG. 1 is a schematic diagram illustrating an exemplary structure of an IoT system for energy-saving control of smart gas terminals according to some embodiments of the present disclosure. As shown in FIG. 1, an IoT system 100 for energy-saving control of smart gas terminals includes a smart gas user platform 110, a smart gas service platform 120, a smart gas management platform 130, a smart gas sensing network platform 140, and a smart gas object platform 150. The smart gas object platform 150 includes a supervisory sensing device and an image acquisition device. The supervisory sensing device and the image acquisition device are disposed at a gas consumption terminal.

The smart gas user platform 110 is an interactive platform directly facing end users. In some embodiments, the smart gas user platform 110 may obtain gas information from the smart gas service platform 120 and present the gas information to users. For example, the presented information includes a gas device status, gas usage data, warning information, etc. In some embodiments, the smart gas user platform 110 may also receive feedback information from users and send the feedback information to the smart gas service platform 120. For example, the feedback information may include online repair requests, complaints and suggestions, service applications, etc. The smart gas user platform 110 is communicatively connected to the smart gas service platform 120.

In some embodiments, the smart gas user platform 110 may include at least one personnel interactive device. For example, a mobile phone, a computer, etc.

The smart gas service platform 120 refers to a platform for receiving and transmitting data and/or information. In some embodiments, the smart gas service platform 120 may be configured as a communication network, a gateway, or other devices. In some embodiments, the smart gas service platform 120 may perform bidirectional data interaction with the smart gas user platform 110 and the smart gas management platform 130.

For example, the smart gas service platform 120 may obtain information such as gas usage data of user terminals and user feedback data from the smart gas user platform 110. In some embodiments, the smart gas service platform 120 may upload information, such as obtained data, to the smart gas management platform 130.

The smart gas management platform 130 is a comprehensive management platform for managing and coordinating connections and collaborations among a plurality of platforms. A gas company may perform digital monitoring management on global gas operations based on the smart gas management platform 130. In some embodiments, the smart gas management platform 130 may coordinate connections and collaborations among various functional platforms, aggregate all information of the IoT, and generate and execute instructions by analyzing and processing data and/or information generated during gas operations.

In some embodiments, the smart gas management platform 130 may be configured in a processor and/or a server. The processor and/or the server may process data and/or information obtained from other platforms. The processor and/or the server may execute program instructions based on the data, the information, and/or processing results to perform one or more functions described in the present disclosure.

The smart gas sensing network platform 140 refers to a communication transmission platform that enables bidirectional data interaction between various functional platforms managed by a gas company. The smart gas sensing network platform 140 may be configured as a communication device and/or a server.

In some embodiments, the smart gas sensing network platform 140 may connect the smart gas management platform 130 and the smart gas object platform 150 to implement functions of sensing communication of perception information and sensing communication of control information.

The smart gas object platform 150 may be a functional platform for generating perception information. In some embodiments, the smart gas object platform 150 may be configured as various sensing devices. For example, the smart gas object platform 150 may include a supervisory sensing device, an image acquisition device, a sound acquisition device, a gas sampling device, etc.

In some embodiments, the smart gas object platform 150 may perform data interaction with the smart gas sensing network platform 140. For example, the smart gas object platform 150 may obtain data related to gas operation from the gas consumption terminal and upload the data to the smart gas management platform 130 through the smart gas sensing network platform 140.

The gas consumption terminal refers to a terminal device where a user uses gas. For example, the gas consumption terminal may include a food processing boiler, a metallurgical blast furnace, a chemical reaction kettle, etc. In some embodiments, the gas consumption terminal may be provided with the supervisory sensing device, the image acquisition device, the sound acquisition device, the gas sampling device, etc.

The supervisory sensing device refers to a sensing device configured to monitor/detect a gas usage state. For example, the supervisory sensing device may include a gas flow meter, a thermometer, a gas detector, etc. In some embodiments, the supervisory sensing device may be configured to obtain the gas usage data. The gas usage data may include a gas flow rate, a gas flow velocity, a gas pressure, a gas consumption, etc., of a user during a gas usage time period.

The image acquisition device refers to a sensing device configured to monitor/detect a gas combustion state. For example, the image acquisition device may include an optical gas thermal imager, etc. In some embodiments, the image acquisition device may be configured to obtain gas image data. The gas image data may include a combustion flame image, a thermal imaging image, etc., of a user during a gas usage time period.

The sound acquisition device refers to a sensing device configured to monitor/detect a sound of gas combustion. For example, the sound acquisition device may include a microphone, an audio analyzer, etc. In some embodiments, the sound acquisition device may be configured to obtain gas sound data. The gas sound data may include an irregular sound generated by combustion of impurities in the gas, or a backfire sound generated by incomplete combustion of the gas.

The gas sampling device refers to a sensing device configured to detect a gas component in the gas. For example, the gas sampling device may include a gas analyzer, a gas detector, etc. In some embodiments, the gas sampling device may be configured to obtain a gas component before and after gas combustion. The gas component may include CH₄, CO, CO₂, etc.

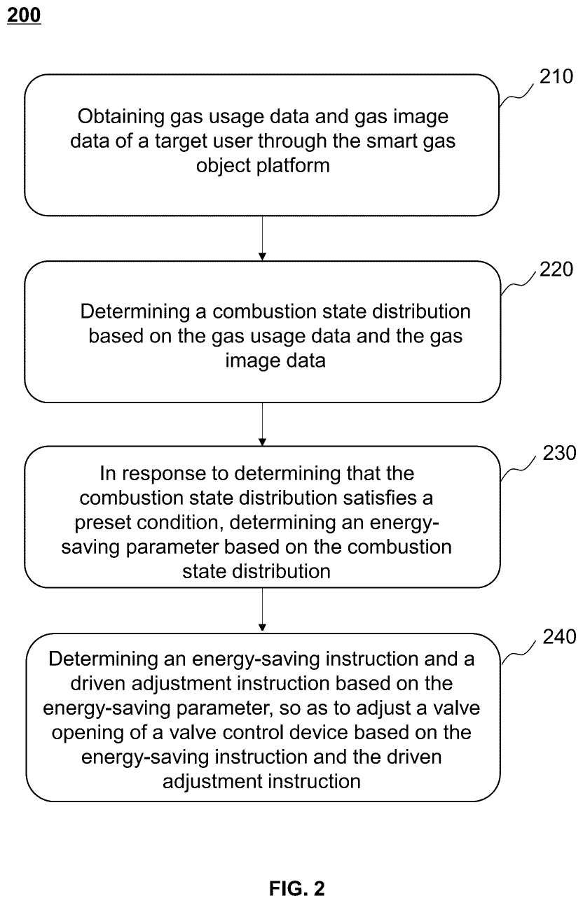

For more content about the gas usage data, the gas image data, the gas sound data, and the gas component, refer to FIG. 2-FIG. 4 and related descriptions. FIG. 2 is a flowchart illustrating an exemplary process for energy-saving control of smart gas terminals according to some embodiments of the present disclosure. As shown in FIG. 2, a process 200 includes the following steps. In some embodiments, the process 200 may be performed by the smart gas management platform.

Step 210, obtaining gas usage data and gas image data of a target user through the smart gas object platform.

In some embodiments, the smart gas management platform may obtain the gas usage data and the gas image data of the target user through a supervisory sensing device and an image acquisition device, respectively, based on the smart gas object platform. The target user refers to a user who uses gas. For example, the target user includes an enterprise, an institution, a household user, etc., that uses gas. For more content about the supervisory sensing device, the image acquisition device, refer to FIG. 1 and related descriptions.

Step 220, determining a combustion state distribution based on the gas usage data and the gas image data.

The combustion state distribution may characterize a degree of incomplete combustion of the gas. In some embodiments, the combustion state distribution may include a gas impurity content and an incomplete combustion value. For example, the gas impurity content may include a content of CO₂, dust, water, etc. When the gas is incompletely combusted, CO is generated while generating CO₂. The incomplete combustion value refers to a mass proportion of CO in substances generated after incomplete combustion of the gas. For example, the incomplete combustion value=a content of CO/(the content of CO+a content of CO₂).

In some embodiments, the smart gas management platform may construct a to-be-matched vector based on the gas usage data and the gas image data. The smart gas management platform performs a search in a vector database based on the to-be-matched vector, and obtains a reference vector with a smallest vector distance from the to-be-matched vector as a target vector. The vector database stores a plurality of reference vectors and combustion state distributions corresponding to the reference vectors. The smart gas management platform determines a combustion state distribution corresponding to the target vector as a currently required combustion state distribution. The combustion state distribution is obtained based on practical experience and historical data. The reference vector is constructed based on historical gas usage data and historical gas image data.

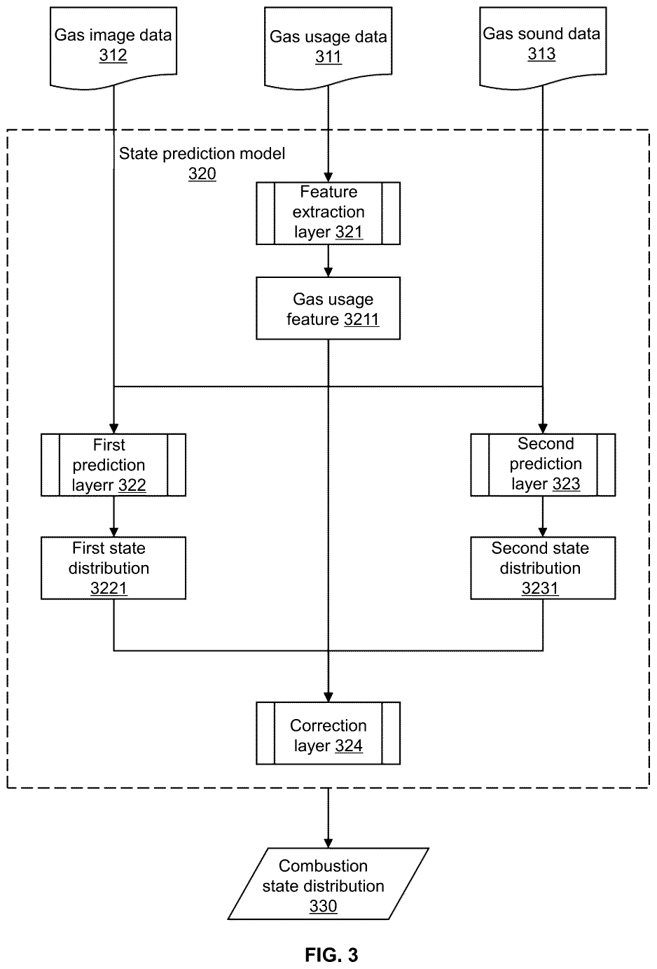

For more content about determining a combustion state distribution, refer to FIG. 3 and related descriptions.

Step 230, in response to determining that the combustion state distribution satisfies a preset condition, determine an energy-saving parameter based on the combustion state distribution.

The preset condition may include an incomplete combustion value being greater than a completeness threshold. The completeness threshold refers to a preset value for complete combustion of gas. Merely by way of example, the higher the impurity content of the gas, the lower the completeness threshold.

The energy-saving parameter refers to a gas flow rate in an adjacent pipeline of the gas consumption terminal. The adjacent pipeline refers to a pipeline that directly supplies gas to the target user.

In some embodiments, the energy-saving parameter may be adjusted based on the incomplete combustion value and the completeness threshold. Merely by way of example, the energy-saving parameter may be obtained based on the following formula (1):

$${V}_{1} = {V}_{0} * ( 1 + \frac{a - b}{a} ) \qquad ( 1 )$$

Where V₁ represents the energy-saving parameter (i.e., the gas flow rate in the adjacent pipeline), V₀ represents a current gas flow rate in the adjacent pipeline, a represents the completeness threshold, and b represents the incomplete combustion value.

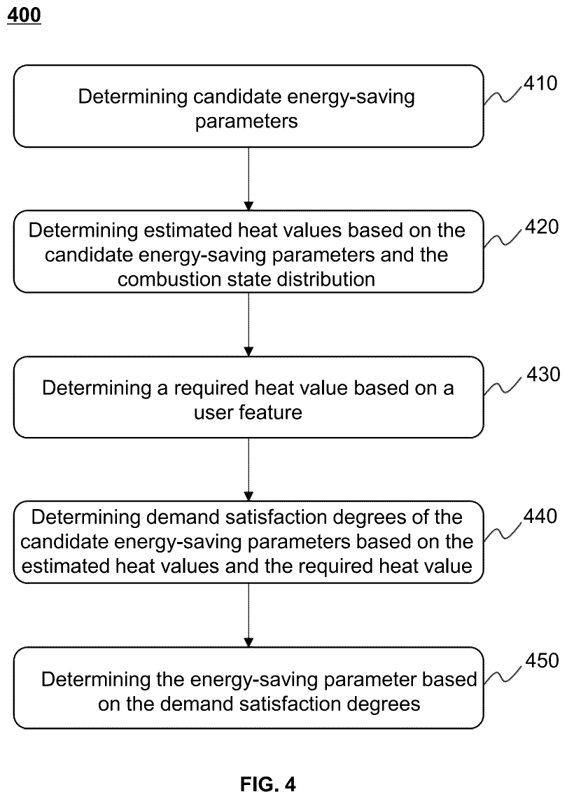

For more content about determining the energy-saving parameter, refer to FIG. 4 and related descriptions.

Step 240, determining an energy-saving instruction and a driven adjustment instruction based on the energy-saving parameter, so as to adjust a valve opening of a valve control device based on the energy-saving instruction and the driven adjustment instruction.

The energy-saving instruction refers to an instruction for adjusting the gas flow rate in the adjacent pipeline. In some embodiments, the energy-saving instruction may include an instruction for adjusting a valve opening of at least one valve control device (hereinafter referred to as a target valve) in the adjacent pipeline.

The driven adjustment instruction refers to an instruction for adjusting a gas flow rate in an upstream pipeline (hereinafter referred to as an auxiliary pipeline) of the adjacent pipeline. A gas flow direction is from the auxiliary pipeline to the adjacent pipeline. The driven adjustment instruction may include an instruction for adjusting a valve opening of at least one valve control device (hereinafter referred to as an auxiliary valve) in the auxiliary pipeline. In some embodiments, the driven adjustment instruction may include step value adjustment or linear gradual adjustment, to reduce a variation amplitude of the gas flow rate in the pipeline network, thereby ensuring flow rate stability of the entire gas pipeline network.

The valve control device refers to a valve device for adjusting a gas flow rate in a pipeline, and may include an electric control valve, a pneumatic control valve, etc. The valve opening refers to an opening degree of the valve control device.

In some embodiments, the smart gas management platform may determine a valve opening of the target valve by querying a preset table based on the energy-saving parameter. The preset table may include a correspondence between the gas flow rate in the adjacent pipeline and the valve opening of the target valve. In some embodiments, the preset table may be obtained through experiments or set manually.

In some embodiments, the driven adjustment instruction may be determined based on the energy-saving parameter and a distance between the auxiliary valve and the target valve. Merely by way of example, a variation amplitude of the valve opening of the auxiliary valve of the auxiliary pipeline may be obtained based on the following formula (2):

$$B = {K}_{1} * ( \frac{{L}_{1} - {L}_{0}}{{L}_{0} * D} ) \qquad ( 2 )$$

Where B represents the variation amplitude of the valve opening of the auxiliary valve, K₁ represents a current valve opening of the auxiliary valve, L₁ represents the valve opening of the target valve after executing the energy-saving instruction, L₀ represents the valve opening of the target valve before executing the energy-saving instruction, and D represents a distance between the auxiliary valve and the target valve.

After determining the variation amplitude of the valve opening of each auxiliary valve, the smart gas management platform may determine a valve opening after adjustment of each auxiliary valve in the driven adjustment instruction based on the current valve opening of each auxiliary valve and the variation amplitude of the valve opening of each auxiliary valve. For example, the valve opening after adjustment=the current valve opening of the auxiliary valve+the variation amplitude of the valve opening of the auxiliary valve. When the variation amplitude of the valve opening of the auxiliary valve is negative, it indicates that the opening of the auxiliary valve needs to be reduced to decrease the gas flow rate.

In some embodiments of the present disclosure, by evaluating the combustion state and adjusting the energy-saving parameter based on the combustion state, the gas flow rate is appropriately reduced, achieving energy-saving and environmental protection effects while ensuring that the provided gas flow rate meets user requirements.

FIG. 3 is a schematic diagram illustrating an exemplary state prediction model according to some embodiments of the present disclosure.

In some embodiments, as shown in FIG. 3, the smart gas management platform determines a combustion state distribution 330 based on gas usage data 311, gas image data 312, and gas sound data 313 through a state prediction model 320.

For more content about the gas usage data, the gas image data, and the combustion state distribution, refer to FIG. 2 and related descriptions.

The state prediction model is a model for predicting the combustion state distribution. In some embodiments, the state prediction model is a machine learning model. For example, the state prediction model is a neural network (NN) model.

An input of the state prediction model includes the gas usage data, the gas image data, and the gas sound data. An output of the state prediction model includes the combustion state distribution.

The gas sound data refers to data related to sound during a gas combustion process. In some embodiments, the smart gas management platform obtains the gas sound data of the target user through a sound acquisition device. For more content about the sound acquisition device, refer to FIG. 1 and related descriptions.

In some embodiments, the smart gas management platform obtains the state prediction model through training based on a first sample dataset. The first sample dataset includes a plurality of first training samples with first labels. The smart gas management platform may input the plurality of first training samples into an initial state prediction model. The smart gas management platform constructs a loss function based on the output of the initial state prediction model and the first labels. The smart gas management platform iteratively updates parameters of the initial state prediction model based on the loss function. The smart gas management platform terminates iteration when an iteration completion condition is satisfied, thereby obtaining a trained state prediction model. The manner for iterative update includes, but is not limited to, a gradient descent manner. The iteration completion condition includes convergence of the loss function or reaching a threshold count of iterations.

The first training sample includes sample gas usage data, sample gas image data, and sample gas sound data of a sample target user. The first training sample may be obtained based on historical data.

The first label includes an actual combustion state distribution corresponding to the sample target user. In some embodiments, some target users (e.g., industrial users, commercial users, and some residential users) are equipped with a gas sampling device. The smart gas management platform detects gas before combustion through the gas sampling device to obtain a gas impurity content. The smart gas management platform detects gas generated after combustion to obtain a component of the gas after combustion. The smart gas management platform calculates an incomplete combustion value based on the component of the gas after combustion. The smart gas management platform combines the gas impurity content and the incomplete combustion value to obtain the actual combustion state distribution corresponding to the target user.

For more content about the gas sampling device, refer to FIG. 1 and related descriptions. For more content about the gas impurity content and the incomplete combustion value, refer to FIG. 2 and related descriptions.

In some embodiments, for target users not equipped with the gas sampling device, the smart gas management platform performs sampling detection on gas delivered to the gas consumption terminal to obtain the gas impurity content. The smart gas management platform performs a combustion experiment on the sampled gas to obtain the components of the gas after combustion. The smart gas management platform calculates the incomplete combustion value based on the components of the gas after combustion. The smart gas management platform combines the gas impurity content and the incomplete combustion value to obtain the actual combustion state distribution corresponding to the target user.

In some embodiments of the present disclosure, the combustion state distribution is determined through the state prediction model, which enables real-time processing and analysis of a large amount of data, and quickly and accurately determines the combustion state distribution of the target user.

In some embodiments, as shown in FIG. 3, the state prediction model 320 includes a feature extraction layer 321, a first prediction layer 322, a second prediction layer 323, and a correction layer 324. In some embodiments, the feature extraction layer 321, the first prediction layer 322, the second prediction layer 323, and the correction layer 324 are all machine learning models. For example, the feature extraction layer 321, the first prediction layer 322, the second prediction layer 323, and the correction layer 324 are all NN models.

In some embodiments, the feature extraction layer 321 determines gas usage feature 3211 based on the gas usage data 311. The first prediction layer 322 determines a first state distribution 3221 based on the gas usage feature 3211 and the gas image data 312. The second prediction layer 323 determines a second state distribution 3231 based on the gas usage feature 3211 and the gas sound data 313. The correction layer 324 determines the combustion state distribution 330 based on the gas usage feature 3211, the first state distribution 3221, and the second state distribution 3231.

The feature extraction layer is configured to extract the gas usage feature from the gas usage data.

The gas usage feature refers to a feature related to gas usage by the target user. For example, the gas usage feature includes a gas usage time, a gas consumption, etc.

The first prediction layer is configured to determine the first state distribution based on the gas usage feature and the gas image data.

The first state distribution refers to a combustion state distribution predicted based on the gas image data.

The second prediction layer is configured to determine the second state distribution based on the gas usage feature and the gas sound data.

The second state distribution refers to a combustion state distribution predicted based on the gas sound data.

The correction layer is configured to correct the first state distribution and the second state distribution to obtain a final combustion state distribution.

In some embodiments, the state prediction model is obtained by training based on a first sample dataset, the first sample dataset includes a plurality of first training samples and first labels corresponding to the plurality of first training samples, and the first sample dataset is obtained based on a first database, a second database, and a third database.

In some embodiments, the smart gas management platform classifies historical data into the first database, the second database, and the third database based on types of data that may be collected for different target users.

The first database includes the gas usage data, the gas image data, and an actual combustion state distribution of the target user. A first training sample constructed based on the first database includes sample gas usage data and sample gas image data of a sample target user. The first label is an actual combustion state distribution of the sample target user.

The second database includes the gas usage data, the gas sound data, and an actual combustion state distribution of the target user. A first training sample constructed based on the second database includes sample gas usage data and sample gas sound data of a sample target user. The first label is an actual combustion state distribution of the sample target user.

The third database includes the gas usage data, the gas image data, the gas sound data, and an actual combustion state distribution of the target user. A first training sample constructed based on the third database includes sample gas usage data, sample gas image data, and sample gas sound data of a sample target user. The first label is an actual combustion state distribution of the sample target user.

In some embodiments, the smart gas management platform jointly trains the feature extraction layer and the first prediction layer based on a plurality of first training samples constructed based on the first database with the first labels, to obtain a trained first prediction layer. For example, the smart gas management platform inputs the sample gas usage data into an initial feature extraction layer to obtain a gas usage feature output by the initial feature extraction layer, inputs the gas usage feature and the sample gas image data into an initial first prediction layer, constructs a loss function based on an output of the initial first prediction layer and the first label, iteratively updates parameters of the initial first prediction layer and the initial feature extraction layer based on the loss function, and ends the iteration when an iteration completion condition is satisfied, to obtain the trained first prediction layer and feature extraction layer. For more content about iteratively updating, refer to the above descriptions.

After the first prediction layer is trained, the smart gas management platform jointly trains the feature extraction layer and the second prediction layer based on a plurality of first training samples constructed based on the second database with the first labels, using the manner described above, to obtain a trained feature extraction layer and a trained second prediction layer. This trained feature extraction layer acts as the final feature extraction layer.

After the feature extraction layer, the first prediction layer, and the second prediction layer are trained, the smart gas management platform trains the correction layer based on a plurality of first training samples constructed based on the third database with the first labels. The smart gas management platform may input the sample gas usage data into the feature extraction layer to obtain a gas usage feature output by the feature extraction layer, input the gas usage feature and the sample gas image data into the first prediction layer to obtain a first state distribution output by the first prediction layer, input the gas usage feature and the sample gas sound data into the second prediction layer to obtain a second state distribution output by the second prediction layer, input the gas usage data, the first state distribution, and the second state distribution into an initial correction layer, construct a loss function based on an output of the initial correction layer and the first label, iteratively update parameters of the initial correction layer based on the loss function, and end the iteration when an iteration completion condition is satisfied, to obtain the trained correction layer.

In some embodiments, the smart gas management platform, in response to determining that a data volume of at least one of the first database or the second database is less than a data volume threshold, determine a data missing device; determine a hardware self-check instruction based on the data volume and the data volume threshold; send the hardware self-check instruction to the data missing device to obtain a self-check result; and in response to determining that the self-check result satisfies a preset maintenance condition, generate a device maintenance instruction and send the device maintenance instruction to an interactive device to arrange for maintenance personnel to perform maintenance on the data missing device.

The data volume threshold is used to determine whether a data missing device exists. In some embodiments, the data volume threshold may be set based on historical experience. Data volume thresholds corresponding to the first database and the second database may be the same or different.

In some embodiments, the data volume threshold may also be determined based on a required model accuracy. The higher the model accuracy is, the larger the data volume threshold is.

The data missing device refers to a device that cannot collect data normally. For example, the data missing device includes an image acquisition device or a sound acquisition device that cannot collect data normally.

In some embodiments, in response to determining that the data volume of the first database is less than the data volume threshold, the smart gas management platform determines an image acquisition device, from the first database, that cannot collect gas image data as the data missing device. In response to determining that the data volume of the second database is less than the data volume threshold, the smart gas management platform determines a sound acquisition device, from the second database, that cannot collect gas sound data as the data missing device.

The hardware self-check instruction is an instruction for controlling a device to perform a self-check. The hardware self-check instruction includes a device that needs to perform the self-check, etc.

In some embodiments, the smart gas management platform may randomly select a portion of the data missing devices from all the data missing devices for self-check.

In some embodiments, a count of data missing devices that need to perform the self-check is related to the data volume of the corresponding database and the data volume threshold. The smaller the difference between the data volume threshold and the data volume and the larger the data volume threshold, the smaller the count of data missing devices that need to perform the self-check. In some embodiments, the smart gas management platform may calculate a count of data missing devices that need to perform the self-check for each database using the following formula (3):

$$n = \frac{m \times ( T - D )}{T} \qquad ( 3 )$$

Where n is the count of the data missing devices that need to perform the self-check, T is the data volume threshold, D is the data volume, m is a coefficient, and m∈(0, 1].

In some embodiments, m is related to a time interval between a current time and a last self-check. The larger the time interval, the larger the m.

The self-check result refers to a result after the data missing device performs the self-check. The self-check result includes functional abnormality, functional normal but not enabled, functional normal and enabled, etc.

In some embodiments, the data missing device, in response to receiving the hardware self-check instruction, performs the self-check according to an internally stored self-check procedure to obtain the self-check result.

In some embodiments, the sound acquisition device includes a sound generating component, an acquisition component, and a microprocessing component, and the sound acquisition device is further configured to: in response to determining that the hardware self-check instruction is received, generate a test sound wave through the sound generating component and synchronously acquire environmental sound wave data through the acquisition component; match the environmental sound wave data with standard sound wave data through the microprocessing component to obtain matching information, and send the matching information to the smart gas management platform. The smart gas management platform determines the self-check result of the sound acquisition device based on the matching information.

The sound generating component is a component for generating sound. For example, the sound generating component includes an electronic component such as a speaker.

In some embodiments, the sound generating component is configured to generate the test sound wave, and a frequency of the test sound wave is close to a frequency of a sound generated during gas combustion.

The acquisition component is a component configured to convert a sound signal into an electrical signal. For example, the acquisition component includes an audio acquisition device such as a microphone.

The microprocessing component is a component configured to process the electrical signal. For example, the microprocessing component includes a central processing unit (CPU), a digital signal processor (DSP), or the like.

The environmental sound wave data refers to data related to sound in an environment where the sound acquisition device is located.

The matching information reflects a matching situation between the environmental sound wave data and the standard sound wave data. For example, the matching information includes a matching degree between the environmental sound wave data and the standard sound wave data. In some embodiments, the microprocessing component compares waveforms of the environmental sound wave data and the standard sound wave data, and determines the matching degree based on a similarity between the waveforms. The greater the similarity between the waveforms, the greater the matching degree.

The standard sound wave data is sound wave data pre-stored in the microprocessing component. In some embodiments, the microprocessing component generates an electrical signal based on the standard sound wave data, and the sound generating component converts the electrical signal into the sound signal, thereby generating the test sound wave.

In some embodiments, the smart gas management platform compares the matching information with a preset matching threshold. In response to determining that the matching degree is less than the preset matching threshold, the smart gas management platform determines the self-check result of the sound acquisition device corresponding to the matching information as a functional abnormality.

In some embodiments, the preset matching threshold is related to a flow velocity of an adjacent pipeline of the gas consumption terminal corresponding to the matching information. The greater the flow velocity of the adjacent pipeline, the smaller the preset matching threshold.

The greater the flow velocity of the adjacent pipeline, the greater the noise in a gas usage environment, which may interfere with the test sound wave. By appropriately reducing the preset matching threshold, the accuracy of determining the self-check result may be improved.

The preset maintenance condition is used to determine whether to perform maintenance on a device. In some embodiments, the preset maintenance condition is that the self-check result is a functional abnormality or that the self-check result is not received.

The device maintenance instruction is an instruction for arranging personnel to perform maintenance on the device. The device maintenance instruction includes the device requiring maintenance.

In some embodiments, after the device maintenance is completed, the smart gas management platform continuously obtains the gas image data and/or the gas sound data and stores the data in a corresponding database.

In some embodiments of the present disclosure, when the data volume in the database is less than the data volume threshold, a part of data missing devices are controlled to perform a self-check, and maintenance is performed on the devices based on the self-check result, thereby increasing the data volume in the database and further improving the training effect of the state prediction model.

In some embodiments, an input of the correction layer further includes a user feature. A training process of the state prediction model includes: dividing a first sample dataset into a training set and a testing set according to a preset rule based on user features corresponding to a plurality of first training samples in the first sample dataset; and training and testing an initial state prediction model based on the training set and the testing set to obtain the state prediction model, wherein a learning rate corresponding to each first training sample of a plurality of first training samples in the training set is related to an iteration round in which the each first training sample is located and a subsequent energy-saving amplitude.

The user feature refers to a feature related to the target user. For example, the user feature includes a user type, an average gas consumption, etc. The user type includes a residential user, a commercial user, an industrial user, a government user, etc. The average gas consumption may be a daily average/weekly average/monthly average gas consumption of the target user.

In some embodiments, the smart gas management platform obtains the user type through the smart gas service platform, and calculates the average gas consumption of the target user based on the gas usage data.

In some embodiments, the smart gas management platform divides the average gas consumption into a plurality of ranges, combines the plurality of ranges of the average gas consumption with the plurality of user types to obtain a plurality of combination types, and classifies data in the first sample dataset according to the combination types.

In some embodiments, the smart gas management platform divides data of each combination type into the training set and the testing set according to the preset rule. The preset rule may be a data division based on a preset ratio. For example, the preset ratio is 7:3 for a data volume ratio of the training set to the testing set.

In some embodiments, the smart gas management platform updates model parameters of the initial state prediction model based on the training set, evaluates a performance indicator of the trained initial state prediction model based on the testing set, and then determines final model parameters of the state prediction model.

In some embodiments, the learning rate corresponding to each first training sample in the training set is negatively correlated with the iteration round in which the first training sample is located, and is positively correlated with the subsequent energy-saving amplitude.

The subsequent energy-saving amplitude is used to evaluate an effect of energy-saving adjustment of the first training sample after a sampling time. In some embodiments, the smart gas management platform determines the energy-saving parameter based on an actual combustion state distribution corresponding to the first training sample, and performs energy-saving adjustment based on the energy-saving parameter. The subsequent energy-saving amplitude may be expressed as a ratio of a difference between average gas consumptions before and after the energy-saving adjustment to the average gas consumption before the energy-saving adjustment.

In some embodiments of the present disclosure, the first sample dataset is divided into the training set and the testing set based on the user feature, and the initial state prediction model is trained and tested based on the training set and the testing set to obtain a more accurate state prediction model. By setting an appropriate learning rate, the convergence rate of a loss function can be increased, and the model training effect can be improved.

Due to limitations of hardware conditions, some target users may be unable to collect the gas image data or the gas sound data. Through a multi-layer design of the state prediction model, accurate prediction of the combustion state distribution can be achieved in a situation of data missing, and the application scope of the model is broader.

FIG. 4 is a flowchart illustrating an exemplary process for determining an energy-saving parameter according to some embodiments of the present disclosure. As shown in FIG. 4, a process 400 includes the following steps. In some embodiments, the process 400 may be performed by the smart gas management platform.

Step 410, determining candidate energy-saving parameters.

The candidate energy-saving parameters refer to energy-saving parameters available for selection. For more content about the energy-saving parameter, refer to FIG. 2 and related descriptions.

In some embodiments, the smart gas management platform determines N energy-saving parameters with a highest usage frequency in historical data as the candidate energy-saving parameters. N may be set based on experience.

In some embodiments, N is positively correlated with a precision of energy-saving adjustment.

Step 420, determining estimated heat values based on the candidate energy-saving parameter(s) and a combustion state distribution. For more content about the combustion state distribution, refer to FIG. 2 and related descriptions. One candidate energy-saving parameter corresponds to one estimated heat value.

The estimated heat value refers to an estimated heat value generated by gas combustion after adjustment is performed according to the candidate energy-saving parameter.

In some embodiments, the smart gas management platform constructs a reference vector based on a historical energy-saving parameter and a historical combustion state distribution in the historical data, determines an actual heat value after adjustment based on the historical energy-saving parameter as a label corresponding to the reference vector, and constructs a reference vector library based on the reference vector and the corresponding label.

The smart gas management platform constructs a target vector based on the candidate energy-saving parameter and the combustion state distribution, retrieves in the reference vector library based on the target vector to obtain a reference vector with a greatest similarity to the target vector, and determines a label corresponding to the reference vector as the estimated heat value. The similarity may be determined based on a vector distance. The vector distance includes, but is not limited to, a Euclidean distance, or the like.

In some embodiments, the smart gas management platform determines the estimated heat value through a heating value prediction model based on the candidate energy-saving parameter and the combustion state distribution.

The heating value prediction model refers to a model for determining the estimated heat value. In some embodiments, the heating value prediction model is a machine learning model. For example, the heating value prediction model is a neural network (NN) model, or the like.

An input of the heating value prediction model includes the candidate energy-saving parameter and the combustion state distribution. An output of the heating value prediction model is the estimated heat value.

In some embodiments, the heating value prediction model is obtained by training based on a second sample dataset, and the second sample dataset includes a plurality of second training samples and second labels corresponding to the plurality of second training samples.

A second training sample includes a sample energy-saving parameter and a sample combustion state distribution. The second training sample may be obtained based on historical data.

The second label refers to an actual heat value of the adjusted gas corresponding to the second training sample. In some embodiments, the smart gas management platform obtains a gas component of the gas consumption terminal after adjustment through a gas sampling device. The smart gas management platform calculates the actual heat value by performing a weighted summation based on a heat value and a proportion of each gas component.

For more content about the gas sampling device, refer to FIG. 1 and related descriptions.

A training process of the heating value prediction model is similar to that of the state prediction model. For more content, refer to FIG. 3 and related descriptions.

In some embodiments of the present disclosure, the actual heat value is determined based on the actually acquired gas component, and the model is trained based on the actual heat value to obtain a more accurate heating value prediction model.

Step 430, determining a required heat value based on a user feature.

For more content about the user feature, refer to FIG. 3 and related descriptions.

The required heat value refers to a heat value required by the target user.

In some embodiments, the user feature further includes a gas consumption sequence of the target user. The gas consumption sequence includes a time when the target user uses gas and a corresponding gas consumption. The smart gas management platform calculates a gas consumption per unit time when the target user uses gas based on the gas consumption sequence. The smart gas management platform calculates a heat generated per unit time when the target user uses gas based on the gas consumption per unit time and the gas component. The smart gas management platform determines the heat as the required heat value.

In some embodiments, the required heat value is related to a gas consumption in an area where the target user is located during a preset period.

In some embodiments, the smart gas management platform determines the gas consumption in the area where the target user is located during the preset period based on the gas usage data.

In some embodiments, the larger the gas consumption in the area where the target user is located during the preset period, the larger the required heat value.

In some embodiments of the present disclosure, the required heat value of the user is estimated based on gas usage situations of other users near the user. The obtained required heat value is closer to an actual situation.

Step 440, determining demand satisfaction degrees of the candidate energy-saving parameters based on the estimated heat values and the required heat value.

The demand satisfaction degree reflects a degree to which the estimated heat value may satisfy the required heat value. In some embodiments, the demand satisfaction degree is a ratio of the estimated heat value to the required heat value.

Step 450, determining the energy-saving parameter based on the demand satisfaction degree.

In some embodiments, in response to a determination that there is at least one demand satisfaction degree not less than 100%, the smart gas management platform determines a candidate energy-saving parameter corresponding to a demand satisfaction degree that is not less than 100% and closest to 100% as a finally used energy-saving parameter. In response to a determination that there is no demand satisfaction degree not less than 100%, the smart gas management platform determines a candidate energy-saving parameter corresponding to a demand satisfaction degree closest to 100% as the finally used energy-saving parameter.

In some embodiments of the present disclosure, an appropriate energy-saving parameter is selected through the demand satisfaction degree, which can satisfy the demand of a user to a maximum extent while saving energy and reducing emissions.

The basic concepts have been described above. Obviously, to a person skilled in the art, the above detailed disclosure is merely an example and does not constitute a limitation to the present disclosure. Although not explicitly stated herein, a person skilled in the art may make various modifications, improvements, and amendments to the present disclosure. Such modifications, improvements, and amendments are suggested in the present disclosure. Therefore, such modifications, improvements, and amendments still fall within the spirit and scope of the exemplary embodiments of the present disclosure.

Meanwhile, the present disclosure uses specific words to describe the embodiments of the present disclosure. For example, “one embodiment,” “an embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different locations in the present disclosure does not necessarily refer to the same embodiment. In addition, certain features, structures, or characteristics in one or more embodiments of the present disclosure may be appropriately combined.

In addition, unless explicitly stated in the claims, the order of processing elements and sequences, the use of numbers and letters, or the use of other names in the present disclosure are not used to limit the order of the processes and manners of the present disclosure. Although the above disclosure discusses some inventive embodiments currently considered useful through various examples, it should be understood that such details are for illustrative purposes only. The appended claims are not limited to the disclosed embodiments. Instead, the claims are intended to cover all modifications and equivalent combinations that conform to the substance and scope of the embodiments of the present disclosure. For example, although the implementation of various components described above may be embodied in a hardware device, it may also be implemented as a software only solution, e.g., an installation on an existing server or mobile device.

Similarly, it should be noted that, in order to simplify the expression disclosed in the present disclosure and thereby help the understanding of one or more inventive embodiments, a plurality of features are sometimes grouped into one embodiment, drawing, or description thereof in the foregoing description of the embodiments of the present disclosure. However, this disclosure manner does not mean that the object of the present disclosure requires more features than those mentioned in the claims. Rather, claimed subject matter may lie in less than all features of a single foregoing disclosed embodiment.

In some embodiments, numbers describing components and attribute quantities are used. It should be understood that such numbers used to describe the embodiments are modified by the modifiers “approximately,” “approximate,” or “substantially” in some examples. Unless otherwise stated, “approximately,” “approximate,” or “substantially” indicates that the stated number allows a variation of ±20%. Accordingly, in some embodiments, the numerical parameters used in the specification and claims are approximate values. The approximate values may change according to the characteristics required by individual embodiments. In some embodiments, the numerical parameters should consider the specified count of significant digits and adopt a general manner of digit retention. Although the numerical ranges and parameters used to confirm the breadth of their scope in some embodiments of the present disclosure are approximate values, such numerical values are set as accurately as possible within a feasible range in specific embodiments.

For each patent, patent application, patent application publication, and other materials, such as articles, books, specifications, publications, documents, etc., cited in the present disclosure, the entire content thereof is hereby incorporated into the present disclosure by reference. Application history documents that are inconsistent with or conflict with the content of the present disclosure are excluded. Documents that limit the broadest scope of the claims of the present disclosure (currently or later attached to the present disclosure) are also excluded. It should be noted that if the description, definition, and/or use of terms in the ancillary materials of the present disclosure are inconsistent with or conflict with the content described in the present disclosure, the description, definition, and/or use of terms in the present disclosure shall prevail.

Finally, it should be understood that the embodiments described in the present disclosure are merely used to illustrate the principles of the embodiments of the present disclosure. Other modifications may also fall within the scope of the present disclosure. Therefore, as an example and not by way of limitation, alternative configurations of the embodiments of the present disclosure may be considered consistent with the teachings of the present disclosure. Accordingly, the embodiments of the present disclosure are not limited to the embodiments explicitly described and introduced in the present disclosure.

What is claimed is:

1. An Internet of Things (IoT) system for energy-saving control of smart gas terminals, comprising: a smart gas user platform, a smart gas service platform, a smart gas management platform, a smart gas sensing network platform, and a smart gas object platform sequentially connected;
the smart gas object platform includes a supervisory sensing device and an image acquisition device, the supervisory sensing device and the image acquisition device are disposed at a gas consumption terminal, the supervisory sensing device is configured to acquire gas usage data of a target user, and the image acquisition device is configured to acquire gas image data of the target user;
the smart gas management platform is configured to:
obtain the gas usage data and the gas image data of the target user through the smart gas object platform;
determine a combustion state distribution based on the gas usage data and the gas image data;
in response to determining that the combustion state distribution satisfies a preset condition, determine an energy-saving parameter based on the combustion state distribution; and
determine an energy-saving instruction and a driven adjustment instruction based on the energy-saving parameter, so as to adjust a valve opening of a valve control device based on the energy-saving instruction and the driven adjustment instruction.

2. The system according to claim 1, wherein the smart gas object platform further includes a sound acquisition device disposed at the gas consumption terminal, and the sound acquisition device is configured to acquire gas sound data of the target user;
the smart gas management platform is further configured to:
determine the combustion state distribution through a state prediction model based on the gas usage data, the gas image data, and the gas sound data, wherein the state prediction model is a machine learning model.

3. The system according to claim 2, wherein the state prediction model includes a feature extraction layer, a first prediction layer, a second prediction layer, and a correction layer, and the feature extraction layer, the first prediction layer, the second prediction layer, and the correction layer are all machine learning models;
the feature extraction layer determines a gas usage feature based on the gas usage data;
the first prediction layer determines a first state distribution based on the gas usage feature and the gas image data;
the second prediction layer determines a second state distribution based on the gas usage feature and the gas sound data; and
the correction layer determines the combustion state distribution based on the gas usage feature, the first state distribution, and the second state distribution.

4. The system according to claim 3, wherein the smart gas user platform includes an interactive device;
the state prediction model is obtained by training based on a first sample dataset, the first sample dataset includes a plurality of first training samples and first labels corresponding to the plurality of first training samples, and the first sample dataset is obtained based on a first database, a second database, and a third database;
the smart gas management platform is further configured to:
in response to determining that a data volume of at least one of the first database or the second database is less than a data volume threshold, determine a data missing device;
determine a hardware self-check instruction based on the data volume and the data volume threshold;
send the hardware self-check instruction to the data missing device to obtain a self-check result; and
in response to determining that the self-check result satisfies a preset maintenance condition, generate a device maintenance instruction and send the device maintenance instruction to the interactive device to arrange for maintenance personnel to perform maintenance on the data missing device.

5. The system according to claim 4, wherein the sound acquisition device includes a sound generating component, an acquisition component, and a microprocessing component, and the sound acquisition device is further configured to:
in response to determining that the hardware self-check instruction is received, generate a test sound wave through the sound generating component and synchronously acquire environmental sound wave data through the acquisition component;
match the environmental sound wave data with standard sound wave data through the microprocessing component to obtain matching information, and send the matching information to the smart gas management platform;
the smart gas management platform is further configured to:
determine the self-check result of the sound acquisition device based on the matching information.

6. The system according to claim 3, wherein an input of the correction layer further includes a user feature, and a training process of the state prediction model includes:
dividing a first sample dataset into a training set and a testing set according to a preset rule based on user features corresponding to a plurality of first training samples in the first sample dataset; and
training and testing an initial state prediction model based on the training set and the testing set to obtain the state prediction model, wherein a learning rate corresponding to each first training sample of a plurality of first training samples in the training set is related to an iteration round in which the each first training sample is located and a subsequent energy-saving amplitude.

7. The system according to claim 1, wherein the smart gas management platform is further configured to:
determine candidate energy-saving parameters;
determine estimated heat values based on the candidate energy-saving parameters and the combustion state distribution;
determine a required heat value based on a user feature;
determine demand satisfaction degrees of the candidate energy-saving parameters based on the estimated heat values and the required heat value; and
determine the energy-saving parameter based on the demand satisfaction degrees.

8. The system according to claim 7, wherein the required heat value is related to a gas consumption in an area where the target user is located within a preset period.

9. The system according to claim 7, wherein the smart gas management platform is further configured to:
for each estimated heat value of the estimated heat values, determine the estimated heat value through a heating value prediction model based on a candidate energy-saving parameter corresponding to the estimated heat value and the combustion state distribution, wherein the heating value prediction model is a machine learning model.

10. The system according to claim 9, wherein the smart gas object platform further includes a gas sampling device disposed at the gas consumption terminal, and the gas sampling device is configured to acquire a gas component of the gas consumption terminal;
the heating value prediction model is obtained by training based on a second sample dataset, and the second sample dataset includes a plurality of second training samples and second labels corresponding to the plurality of second training samples.

11. A method for energy-saving control of smart gas terminals, wherein the method is implemented based on an Internet of Things (IoT) system for energy-saving control of smart gas terminals, the system includes a smart gas user platform, a smart gas service platform, a smart gas management platform, a smart gas sensing network platform, and a smart gas object platform sequentially connected;
the smart gas object platform includes a supervisory sensing device and an image acquisition device, the supervisory sensing device and the image acquisition device are disposed at a gas consumption terminal, the supervisory sensing device is configured to acquire gas usage data of a target user, and the image acquisition device is configured to acquire gas image data of the target user;
the method is executed by the smart gas management platform and comprises:
obtaining the gas usage data and the gas image data of the target user through the smart gas object platform;
determining a combustion state distribution based on the gas usage data and the gas image data;
in response to determining that the combustion state distribution satisfies a preset condition, determining an energy-saving parameter based on the combustion state distribution; and
determining an energy-saving instruction and a driven adjustment instruction based on the energy-saving parameter, so as to adjust a valve opening of a valve control device based on the energy-saving instruction and the driven adjustment instruction.

12. The method according to claim 11, wherein the smart gas object platform further includes a sound acquisition device disposed at the gas consumption terminal, and gas sound data of the target user is acquired based on the sound acquisition device;
the determining the combustion state distribution based on the gas usage data and the gas image data includes:
determining the combustion state distribution through a state prediction model based on the gas usage data, the gas image data, and the gas sound data, wherein the state prediction model is a machine learning model.

13. The method of claim 12, wherein the state prediction model includes a feature extraction layer, a first prediction layer, a second prediction layer, and a correction layer, and the feature extraction layer, the first prediction layer, the second prediction layer, and the correction layer are all machine learning models;
the feature extraction layer determines a gas usage feature based on the gas usage data;
the first prediction layer determines a first state distribution based on the gas usage feature and the gas image data;
the second prediction layer determines a second state distribution based on the gas usage feature and the gas sound data; and
the correction layer determines the combustion state distribution based on the gas usage feature, the first state distribution, and the second state distribution.

14. The method of claim 13, wherein the smart gas object platform includes an interactive device;
the state prediction model is obtained by training based on a first sample dataset, the first sample dataset includes a plurality of first training samples and first labels corresponding to the plurality of first training samples, and the first sample dataset is obtained based on a first database, a second database, and a third database;
the method further comprises:
in response to determining that a data volume of at least one of the first database or the second database is less than a data volume threshold, determining a data missing device;
determining a hardware self-check instruction based on the data volume and the data volume threshold;
sending the hardware self-check instruction to the data missing device to obtain a self-check result; and
in response to determining that the self-check result satisfies a preset maintenance condition, generating a device maintenance instruction and sending the device maintenance instruction to the interactive device to arrange for maintenance personnel to perform maintenance on the data missing device.

15. The method of claim 14, wherein the sound acquisition device includes a sound generating component, an acquisition component, and a microprocessing component, and the method further comprises:
obtaining matching information based on the sound acquisition device;
determining the self-check result of the sound acquisition device based on the matching information;
the obtaining matching information includes:
in response to determining that the hardware self-check instruction is received, generating a test sound wave through the sound generating component, and synchronously acquiring environmental sound wave data through the acquisition component; and
matching the environmental sound wave data with standard sound wave data through the microprocessing component to obtain the matching information.

16. The method of claim 13, wherein an input of the correction layer further includes a user feature, and a training process of the state prediction model includes:
dividing a first sample dataset into a training set and a testing set according to a preset rule based on user features corresponding to a plurality of first training samples in the first sample dataset; and
training and testing an initial state prediction model based on the training set and the testing set to obtain the state prediction model, wherein a learning rate corresponding to each first training sample of a plurality of first training samples in the training set is related to an iteration round in which the each first training sample is located and a subsequent energy-saving amplitude.

17. The method of claim 11, wherein the in response to determining that the combustion state distribution satisfies a preset condition, determining an energy-saving parameter based on the combustion state distribution includes:
determining candidate energy-saving parameters;
determining estimated heat values based on the candidate energy-saving parameters and the combustion state distribution;
determining a required heat value based on a user feature;
determining demand satisfaction degrees of the candidate energy-saving parameters based on the estimated heat values and the required heat value; and
determining the energy-saving parameter based on the demand satisfaction degrees.

18. The method of claim 17, wherein the required heat value is related to a gas consumption in an area where the target user is located within a preset period.

19. The method of claim 17, wherein the determining estimated heat values based on the candidate energy-saving parameters and the combustion state distribution includes:
for each estimated heat value of the estimated heat values, determining the estimated heat value through a heating value prediction model based on a candidate energy-saving parameter corresponding to the estimated heat value and the combustion state distribution, wherein the heating value prediction model is a machine learning model.

20. The method of claim 19, wherein the smart gas object platform further includes a gas sampling device disposed at the gas consumption terminal, and a gas component of the gas consumption terminal is acquired based on the gas sampling device;
the heating value prediction model is obtained by training based on a second sample dataset, and the second sample dataset includes a plurality of second training samples and second labels corresponding to the plurality of second training samples.
